(19) United States
(12) Patent Application Publication
(10) Pub. No.: US 2026/0175542 A1
(43) Pub. Date: Jun. 25, 2026

(54) CONSTRUCTION COMPOSITE FILM

(71) Applicant: Ewald Dörken AG, Herdecke (DE)

(72) Inventors: Ronald Flaig, Leverkusen (DE); Thomas Bachon, Düsseldorf (DE); Timo Pleuser, Wermelskirchen (DE); Yvonne Weeke, Essen (DE)

(73) Assignee: Ewald Dörken AG, Herdecke (DE)

(21) Appl. No.: 19/129,591

(22) PCT Filed: Oct. 16, 2023
(86) PCT No.: PCT/EP2023/078601

§ 371 Date: May 13, 2025

(30) Foreign Application Priority Data
Nov. 14, 2022 (DE) 10 2022 130 037.4

(51) Int. Cl. B32B 25/10; B32B 5/02; B32B 5/26; B32B 7/12; B32B 25/14; B32B 27/12; B32B 27/40

(52) U.S. Cl. CPC B32B 25/10; B32B 5/022; B32B 5/277; B32B 7/12; B32B 25/14; B32B 27/12; B32B 27/40; B32B 2250/05; B32B 2262/0253; B32B 2262/0284; B32B 2307/712; B32B 2307/718

(57) ABSTRACT

A multilayer composite construction film for protecting building structures and/or structural components. The composite construction film has a nonwoven layer including a polyolefin and/or a polyester, and a membrane layer including a polyurethane and/or a thermoplastic copolyester elastomer. The composite construction film further has an adhesive layer comprising a contact adhesive, and an open-meshed nonwoven fabric.

This application is the U.S. national stage application of international application PCT/EP2023/078601, filed Oct. 16, 2023, which international application was published May 23, 2024, as international publication WO 2024/104668, which claims priority to German patent application 10 2022 130 037.4, filed Nov. 14, 2022, both of which are incorporated herein by reference in their entireties.

### FIELD

The present invention relates to the technical field of composite construction films.

### SUMMARY

In particular, the invention relates to a composite construction film with a multilayer structure.

Furthermore, the present invention relates to the use of a composite construction film for the, in particular temporary, protection of building structures and/or structural components, in particular wooden structures and/or wooden structural components.

### BRIEF DESCRIPTION OF DRAWINGS

The figure illustrations according to FIG. 1 is a schematic cross-sectional view of a four-layer composite construction film according to the invention;

FIG. 2 is a schematic cross-sectional view of a further four-layer composite construction film according to the invention;

FIG. 3A is a schematic cross-sectional view of a five-layer composite construction film according to the invention;

FIG. 3B is a schematic cross-sectional view of another five-layer composite construction film according to the invention;

FIG. 4A is a schematic cross-sectional view of a six-layer composite construction film according to the invention;

FIG. 4B is a schematic cross-sectional view of another six-layer composite construction film according to the invention;

FIG. 5 is a schematic of a two-layer membrane layer;

FIG. 6 is a schematic of a two-ply layer comprising a nonwoven fabric;

FIG. 7A is a schematic cross-sectional view of a five-layer composite construction film according to the invention with two layers comprising a nonwoven fabric;

FIG. 7B is a schematic cross-sectional view of a further five-layer composite construction firm according to the invention with two layers comprising a nonwoven fabric

FIG. 8 is a schematic top view of a nonwoven fabric;

FIG. 9 is a schematic perspective view of an application of a composite film according to the invention; and

FIG. 10 is a schematic perspective view of a further application of a composite film according to the invention.

### DETAILED DESCRIPTION

Building materials and structures require efficient protection against moisture and damp in all construction phases as well as during transportation, storage and installation of the material. In this context, effective temporary waterproofing is particularly relevant, i.e. resilient protection of building materials and structures against the effects of the weather as well as storage and transport-related mechanical loads, which can contribute to damage to the material, especially visually but also structurally relevant. Accordingly, reliable temporary protection of the building material is important for the period of construction of a building, i.e. the construction period. In particular, it must be taken into account that the building material and structure are temporarily exposed to the effects of the weather in a comparatively unprotected manner during this period.

This is all the more relevant for timber construction. Timber components and structures must be reliably protected against moisture and wetness during transportation, assembly and construction in order to prevent moisture or water from penetrating the material and thus prevent the material or structure from being impaired. To ensure a stable and resilient timber construction, the moisture content of the timber construction material used must not exceed 18%.

The field of timber construction has been gaining relevance in recent years and the trend towards timber construction is increasing due to its sustainable character. Wood is both a renewable raw material and climate-friendly, as its production and processing into a building material is and can be comparatively CO₂-friendly.

On the other hand, wood is more susceptible to moisture penetration, especially during prolonged exposure to the elements, and is less resistant to punctual mechanical loads than concrete components, e.g. to scratching, impact or friction, which can contribute to scratches, dents or abrasions in the building material.

Accordingly, there is a growing need in the timber construction sector for effective and reliable protection for timber construction materials against the effects of the weather, especially during the construction period when the weather can act relatively unhindered on the timber construction material. On the other hand, timber construction materials require resilient protection to prevent damage during transportation, storage or assembly, e.g. due to mechanical forces in the form of friction, impact or scratching, which can lead to visual impairment of the material.

Protective films are known from the state of the art, which are applied to the timber construction material for the period of storage, transportation and assembly or for the entire duration of the construction period and thus protect the wood from the effects of the weather and visual damage.

For example, translucent, self-adhesive protective films are known. However, these have the disadvantage that they are not open to diffusion. This means that any moisture present in the wood can no longer diffuse out of the wood through the protective film after the film has been applied and thus accumulates in the wood. Depending on the degree of moisture, this can result in a considerable impairment of the timber construction material. Diffusion-open, self-adhesive protective films are also known, but these are opaque.

In addition, all films available to date in the state of the art have the problem that they are not sufficiently inherently stable to be laid easily, quickly and above all wrinkle-free, especially on large surfaces, possibly manually.

There is therefore still a need for construction films that can be used specifically as protective films, in particular for the temporary protection of building materials or structures, especially those based on wood, and that also have a high inherent stability and sufficient rigidity, which have a positive effect on both the proper laying of the film and its protective properties.

It is therefore a task of the present invention to overcome the problems and disadvantages associated with the prior art described above, or at least to mitigate them.

In particular, one task of the present invention is to provide a composite construction film which has good weathering properties, i.e. a high water-tightness with simultaneously high water vapor diffusion openness, and at the same time an increased mechanical resistance, inherent stability and rigidity.

The subject matter of the present invention according to a first aspect of the present invention is therefore a composite construction film according to claim 1; further advantageous embodiments of this aspect of the invention are the subject matter of the relevant subclaims.

A further object of the present invention according to a second aspect of the present invention is the use of a composite construction film according to claim 18.

It goes without saying that special embodiments mentioned below, in particular special embodiments or the like, which are described only in connection with one aspect of the invention, also apply in relation to other aspects of the invention, without this requiring explicit mention.

Furthermore, in the case of all relative or percentage, in particular weight-related, quantities mentioned below, it should be noted that these are to be selected by the skilled person within the scope of the present invention in such a way that the sum of the ingredients, additives or auxiliary substances or the like always results in 100% or 100% by weight. However, this is self-evident to the person skilled in the art.

In addition, all the parameter data or the like mentioned below can in principle be determined or ascertained using standardized or explicitly specified determination methods or determination methods that are familiar to the skilled person.

Having said this, the object of the present invention is explained in more detail below.

The object of the present invention—according to a first aspect of the present invention—is a multilayer composite construction film, in particular for the, preferably temporary, protection of building structures and/or structural components, preferably wooden structures and/or wooden structural components, from mechanical and/or weather-related damaging influences, comprising at least one nonwoven layer wherein the nonwoven layer comprises a polyolefin and/or a polyester, at least one membrane layer, wherein the membrane layer comprises a polyurethane and/or a thermoplastic copolyester elastomer, and at least one adhesive layer, wherein the adhesive layer comprises a contact adhesive, wherein the composite film comprises at least one further layer, wherein the further layer comprises an open-meshed nonwoven fabric.

This is because, as the applicant has surprisingly found, the composite construction film according to the invention, in particular on the basis of the further layer comprising a nonwoven fabric, is characterized by a particularly high structural integrity and advantageous rigidity and inherent stability, which in particular significantly simplify the laying and also the application of the film to a building material or a building structure. In particular, the formation of folds can be avoided during laying, especially over large areas, since the composite film according to the invention is sufficiently stable to be able to bear its own weight, in particular at least in certain areas, and thus also has a flatness that can be considered advantageous in this respect.

The composite film according to the invention is particularly suitable for large-area applications or formats and can accordingly be provided, for example, in the form of comparatively wide and long strips. The fact that the composite film can be provided and also laid in large formats also results in a considerable time saving for the user of the protective film, as it is possible to work with fewer small parts and correspondingly quickly, which is particularly positively influenced by the relatively high inherent stability and rigidity as well as good flatness of the film.

Likewise, the composite film according to the invention is also sufficiently flexible so that even irregularly shaped components can be efficiently covered with the film or the film can also be used easily and reliably in the area of corners and edges.

In particular, the comparatively high rigidity and high intrinsic structural integrity of the film is also advantageous in this context for laying or applying the film to irregularly shaped components. The composite film is stable enough to support its own weight in such a way that the film can be applied and processed by the user in a controlled manner, so that the formation of wrinkles or unintentional adhesion of the film can be avoided, for example.

The composite film according to the invention thus enables reliable and efficient protection of building structures and structural components, in particular against the effects of weather and also mechanical damage, for example in connection with transportation and/or storage and also installation of the components. In this respect, the composite film according to the invention can also be understood as a protective film that protects building structures or building materials, in particular during the construction period, from direct weathering as well as, for example, impact, friction, scratching or even pressure, so that the building material remains in as perfect a condition as possible, both structurally and decoratively, until the building is completed. In addition, the high diffusion capacity of the composite film positively favors the drying out of any wooden components that may still be damp.

This is due in particular to the choice of material and the layer structure of the composite film, which ensures a high level of waterproofing, especially against driving rain and similar direct water impact, as well as water vapor permeability and diffusion openness. In addition, the composite film is robust and resistant on the outside, making it ideal for use in unprotected exposed areas. The composite film according to the invention is also designed to be weight-optimized, which should be emphasized in particular in connection with the user-friendliness of the composite film. As the composite film is preferably also transparent, the objects covered with the composite film remain completely visible, so that their condition and integrity can be ideally observed and tracked, in particular during the construction period. Markings for the subsequent positioning of other components, such as walls etc., or even penetrations also remain clearly visible thanks to the transparent design. To further facilitate the processing of building materials, structural components or even building structures, additional printing on the composite film has proven to be advantageous.

Overall, the present invention thus provides an ideally matched composite film for use as, in particular temporary, protection of building structures or structural components, in particular wooden structures or wooden components, against mechanical and/or weather-related damaging influences, in particular impact, shock, friction and/or scratching and/or driving rain, increased humidity, waterlogging. In particular, the composite film according to the invention is ideally suited for the protection of structures or components from storage to transportation and installation or assembly until the end of the construction period, so that the composite film according to the invention can in this respect also be understood in particular as a construction period protection film.

According to the invention, it is provided that the composite film comprises at least one nonwoven layer. As far as this is concerned, the nonwoven layer can in principle be designed in a variety of ways. In the context of the present invention, it has proved useful if the composite film has one or more, in particular several, preferably two, nonwoven layers.

In this context, it has proven to be advantageous if the nonwoven layer is designed as a carrier layer, in particular as a protective layer, preferably outer and/or inner, preferably for the membrane layer and/or the further layer comprising a nonwoven fabric.

A carrier layer refers to a nonwoven layer that is designed in such a way that the other layers of the composite film can be applied to it and thus, depending on the application of the resulting composite film, forms a type of base or top layer or a nonwoven bottom layer or a nonwoven top layer. In this respect, the nonwoven layer is also to be understood as the outer or external or outward-facing layer and, in particular, the side of the composite film. It thus serves as a barrier or shield on the one hand for the other layers and on the other hand for objects covered with the composite film, e.g. building structures and/or structural components, in particular made of wood, against external influences.

In the form of a base layer or a sub-layer, the nonwoven layer is arranged in the composite film in such a way that further layers follow on top of the nonwoven layer, whereby the nonwoven base layer or the sub-layer can be arranged both on the outside and on the inside. A nonwoven layer designed as a base layer or sub-layer can therefore be a carrier layer that closes off the bottom side of the composite film, or a carrier layer on which further layers are arranged on both sides of the nonwoven layer. In both cases, the nonwoven layer serves as a base or foundation for the further structure of the layers of the composite film according to the invention. It is preferable for the nonwoven layer designed as a base layer or sub-layer to be arranged on the inside of the composite film. In this case, for example, the membrane layer and/or the other layer comprising an open-meshed nonwoven fabric are arranged on one side of the nonwoven layer and the adhesive layer is applied to the side of the nonwoven layer facing away from it. This embodiment has the advantage, for example, that a time-efficient construction of the composite film according to the invention is possible.

The nonwoven layer of composite films according to the invention thus advantageously ensures that both the building material on which the composite film is laid and the other layers of the composite film are protected from external influences, for example direct weathering or mechanical stress, for which purpose the nonwoven layer can be arranged in the composite film in different configurations, for example both as an outer top layer or nonwoven top layer and as an inner base layer or as a nonwoven bottom layer.

In the preferred embodiment, according to which the composite film according to the invention comprises several, in particular two, nonwoven layers, this protective effect is additionally reinforced. In this respect, it has proved particularly useful if at least one of the several or, in particular, two nonwoven layers is designed as a carrier layer and/or inner protective layer, i.e. as a base layer or also as a sub-layer. Similarly, it is preferred if at least one of the several or, in particular, two nonwoven layers is designed as a carrier layer and/or outer protective layer, i.e. as a top or nonwoven top layer.

Experience has shown that a large number of materials familiar to the skilled person can be used for the nonwoven layer of composite films. According to the invention, it is provided that the nonwoven layer comprises a polyolefin and/or a polyester. Preferably, it may also be provided that the nonwoven layer comprises the polyolefin and/or polyester.

It has proven to be advantageous if the polyolefin of the nonwoven layer is selected from the group of polyolefin homopolymers, in particular polyethylene, polypropylene, polybutylene, preferably polyethylene, polypropylene, polyolefin copolymers, in particular ethylene copolymers, propylene copolymers, butylene copolymers, preferably ethylene copolymers, propylene copolymers, and mixtures thereof.

Likewise, it has proved useful in the context of the present invention if the polyester is selected from the group of polyethylene terephthalate, polybutylene terephthalate, polytrimethylene terephthalate, polyethylene furanoate, copolymers thereof and mixtures or blends thereof, preferably polyethylene terephthalate, polyethylene furanoate, copolymers thereof and mixtures or blends thereof.

In this context, a copolymer is to be understood as a polymer which has been produced from at least two different types of monomers, whereby the mass fraction of the monomer which is decisive for the designation of the copolymer is at least 50%.

Finally, it is particularly preferable if the nonwoven layer comprises polypropylene, in particular consists of polypropylene.

It is also particularly preferred if the nonwoven layer comprises polyethylene terephthalate, especially if it consists of polyethylene terephthalate.

The above-mentioned polyolefins and polyesters allow the nonwoven layer to be produced in a cost-efficient manner, which can also be applied to the composite film according to the invention. In addition, the polymers mentioned are characterized by an advantageous property profile with regard to the effects intended to be achieved with the composite film according to the invention, in particular with regard to durability and resistance.

In addition to the choice of material for the nonwoven layer, the grammage of the nonwoven layer can also have an advantageous effect on the properties of composite films according to the invention. In the context of the present invention, it has proved useful if the nonwoven layer has a grammage in the range of 70 g/m² or less, in particular 55 g/m² or less, preferably 50 g/m² or less, preferably 45 g/m² or less. Thus, according to the invention, comparatively thin or light nonwoven layers are preferred. This has a correspondingly advantageous effect on the overall weight of the composite film according to the invention, while nevertheless ensuring that sufficiently stable and durable composite films are also obtained.

In the preferred embodiment of the composite film according to the invention, which provides for several, in particular two, nonwoven layers, it has also proven to be advantageous if the nonwoven layers are of different thicknesses or weights, i.e. have different grammages, depending on their design as a top or nonwoven top layer or as a base layer or nonwoven bottom layer, but in particular depending on their arrangement as an outer and/or inner nonwoven layer or protective layer. For nonwoven layers, which in the case of application represent an outward-facing or final protective or nonwoven top or cover layer, it has proven to be useful if this nonwoven layer has a, in particular slightly, higher grammage than internally arranged nonwoven base layers or bottom nonwovens. Similarly, internally arranged or inner nonwoven layers preferably have a lower grammage, especially slightly, than externally arranged or outer nonwoven layers. It is advantageous, for example, if the difference between the grammages of the inner nonwoven layer and the outer nonwoven layer is in the range of 2 to 40 g/m², in particular 4 to 35 g/m², preferably 5 to 30 g/m², preferably 6 to 25 g/m².

Grammages in a range of 50 g/m² or less, in particular 45 g/m² or less, preferably 40 g/m² or less, preferably 35 g/m² or less, have proven to be particularly advantageous for internally arranged or inner nonwoven layers. It is particularly preferred that the grammage for internally arranged or inner nonwoven layers is in the range of 28 to 33 g/m².

In contrast, a grammage in the range of 70 g/m² or less, in particular 55 g/m² or less, preferably 50 g/m² or less, preferably 45 g/m² or less, has proven to be advantageous for externally arranged or outer nonwoven layers. The grammage for outer nonwoven layers is particularly preferably in the range from 40 to 45 g/m².

Good results are also achieved in the context of the present invention if the nonwoven layer has a layer thickness in the range of 0.01 mm to 2.5 cm, in particular 0.05 mm to 1.5 cm, preferably 0.1 mm to 1 cm.

For the particular embodiment of the present invention described above, i.e. in the event that the composite film according to the invention has several, in particular two, nonwoven layers, it is therefore particularly preferred if the composite film has an asymmetrical layer structure in relation to the several or in particular two nonwoven layers, and in particular their grammage.

Advantageously, by providing outer nonwoven layers with a higher grammage and a correspondingly higher thickness, particularly effective protection against direct weathering and external mechanical influences can be achieved, so that, for example, a component covered with the composite construction film according to the invention can be effectively protected against damaging external influences. Likewise, internally arranged nonwoven layers, irrespective of their comparatively thin or lightweight design, allow efficient protection, in particular of the membrane layer or the composite film as a whole, against damage caused by smaller pieces of material, e.g. wood splinters, which could penetrate the film and thus impair its functionality.

As far as the further design of the nonwoven layer is concerned, this can be varied in many ways. In the context of the present invention, it has proven useful if the nonwoven layer is colorless, in particular translucent, preferably transparent.

It has also proved to be advantageous in the context of the present invention if the nonwoven layer is formed as a spunbonded nonwoven and/or as a needled nonwoven. It is further preferred if the nonwoven layer is formed as a mechanically, chemically and/or thermally, preferably thermally, bonded nonwoven layer. Preferably, the nonwoven layer is designed as a thermally bonded or needle-punched or wet-blast bonded nonwoven layer. In this way, a high resistance of the nonwoven layer can be achieved, especially against mechanical stress. A consolidated or compacted structure, in particular a fiber structure, of the nonwoven layer also provides a certain barrier effect against the penetration of damaging UV radiation, for example.

It is also preferable if the nonwoven layer is slip-resistant. This is particularly advantageous for embodiments of the composite film according to the invention which comprise several nonwoven layers, wherein one of the nonwoven layers is designed as an outer carrier or protective layer and/or as a cover nonwoven, since in this way, for example, it is safer to walk on areas covered with the composite film according to the invention.

As far as the membrane layer of composite films according to the invention is concerned, this can be designed in a variety of ways. In the context of the present invention, it has proved useful if the composite film has one or more, in particular one or more single-layer or multi-layer, preferably a single-layer, membrane layer.

If the membrane layer has several, i.e. at least two, layers of membrane layers, it may be provided that the membrane layer layers are formed differently or are at least essentially identical. Differently designed layers can result, for example, with regard to the selection of the polyurethane or copolyester elastomer or also the grammage. In addition to a two-layer structure, a three- or even four-layer membrane structure is also conceivable, depending on the application or conditions. In particular, in the case of a three-layer structure of the membrane layer, it is possible that the outer membrane layers, which surround a central membrane layer, are at least essentially identical, in particular whereby the outer membrane layers are preferably designed to be resistant to ageing or weathering.

Identical design means that the membrane layers have the same surface properties and/or the same material and/or the same material composition. Ultimately, the identical membrane layers can also have the same function. For example, the grammages of the identically formed membrane layers can differ from each other by less than 5 g/m²

With regard to the structure of the composite film according to the invention, it has also proved advantageous in the context of the present invention if the membrane layer is designed as a functional layer, in particular arranged on the inside of the composite film. By an internal arrangement in the composite film is meant an arrangement of the membrane layer such that it is surrounded or enclosed by further layers of the composite film and is thus arranged inside the composite film.

With regard to the material of the membrane layer, the invention provides that the membrane layer comprises or consists of a polyurethane and/or a thermoplastic copolyester elastomer.

Furthermore, it is preferably provided that the membrane layer comprises or consists of a thermoplastic polyurethane (TPU) and/or a thermoplastic copolyester elastomer. It is particularly preferred in the context of the present invention if the membrane layer comprises a thermoplastic polyurethane (TPU) or consists of a thermoplastic polyurethane (TPU).

Particularly good results are obtained in this context if the thermoplastic polyurethane (TPU) is selected from the group of aliphatic and aromatic polyurethanes of the ether type, the polyester type and the carbonate type, in particular aromatic polyurethanes of the ether type, the polyester type and the carbonate type. In a particularly preferred embodiment of the present invention, it may further be provided that the membrane layer comprises the, in particular thermoplastic, polyurethane.

In the context of the present invention, a thermoplastic polyurethane is to be understood as a thermoplastic elastomer which is formed from polyurethane.

In the context of the present invention, a thermoplastic copolyester elastomer is to be understood as a thermoplastic elastomer based on polyester copolymers.

Thermoplastic elastomers are plastics that exhibit elastomeric behavior at room temperature but thermoplastic behavior when heat is applied. A particular advantage of thermoplastic elastomers is that, compared to pure elastomers, they can be reversibly reshaped at any time under the influence of heat. Thermoplastic polyurethanes are polyurethanes which have a hard segment and a soft segment, whereby the soft segment is usually formed by an oligomeric or polymeric polyol and the hard segment consists of a diisocyanate which has short-chain diols as chain extenders.

In the context of the present invention, an ether-type thermoplastic polyurethane or an ether TPU is to be understood as a thermoplastic polyurethane whose soft segment is composed of polyethers. Depending on the number of carbon atoms in the chain between the ether functionalities of the alkylene residue, the thermoplastic ether polyurethanes are subdivided, with C2 ether polyurethanes, C3 ether polyurethanes and C4 ether polyurethanes being the most widely used.

In the context of the present invention, a polyester-type thermoplastic polyurethane or a polyester TPU is to be understood as a thermoplastic polyurethane whose soft segment is formed from polyester polyols, in particular polyester diols. In the context of the present invention, an ether-ester type thermoplastic polyurethane or an ether-ester TPU is a polyurethane whose soft segment is formed from polyethers or oligoethers and polyesters.

In the context of the present invention, a thermoplastic polyurethane of the carbonate type or a carbonate TPU is formed by a polyol, in particular a diol, which has a structural element of a carbonic acid diester.

With regard to the different properties of the various TPUs, aromatic ester TPUs and aromatic ether ester TPUs have a relative sensitivity to hydrolysis and only moderate weathering properties. However, they have an inherent flame-retardant effect and good mechanical properties, such as low tear resistance and high abrasion resistance.

Aromatic carbonate TPUs have an excellent inherent flame-retardant effect as well as very good weathering stability and are also highly resistant to hydrolysis and heat storage. However, aromatic carbonate TPUs are cost-intensive to produce, which is why they have so far only been used occasionally in special applications.

In view of the numerous types of different TPUs and the various physical and chemical properties of these described, it has also proved advantageous in the context of the present invention if the aforementioned different TPUs are combined with one another in the membrane layer.

With regard to the thermoplastic copolyester elastomer, this preferably comprises block copolymers, in particular with blocks of polyesters and polyethers. It is therefore preferably a thermoplastic ether ester block copolymer (TPC or TPEE).

TPC or TPEE layers good or high tear resistance with high strength and rigidity while ensuring resistance to liquids. A monolithic TPC or TPEE membrane is also easy to extrude and is also suitable for thin membranes. In particular, a membrane layer containing TPC or TPEE is suitable for a multilayer coextruded web and makes sense from a technical point of view.

Furthermore, with regard to the further design of the membrane layer, it has proven useful if the membrane layer has a grammage in the range of 40 g/m² or less, in particular 35 g/m² or less, preferably 30 g/m² or less, preferably 28 g/m² or less.

It has also proven to be advantageous if the membrane layer has a thickness in the range of 0.01 mm to 2.5 cm, in particular 0.05 mm to 1.5 cm, preferably 0.1 mm to 1 cm.

For composite films according to the invention, particularly thin or lightweight membrane layers can therefore be used for an overall weight-optimized composite film, whereby it is also advantageously ensured for these thin or lightweight membrane layers that they reliably retain their functionality.

Furthermore, according to the invention, it is preferably provided that the membrane layer is monolithic. A monolithic membrane layer is understood in particular to be a non-porous layer of a membrane. Monolithic membrane layers can provide particularly good protection against driving rain while at the same time being open to diffusion. In contrast to conventional microporous membrane layers, moisture can be actively transported along the molecular chains of the materials from which the membrane layer is formed by diffusion.

As far as the water vapor permeability of the membrane layer is concerned, it has proven to be advantageous if the membrane layer has an S_{d} value according to DIN EN ISO 12572 of less than 0.75 m, in particular less than 0.5 m, preferably less than 0.3 m, preferably less than 0.2 m. Equally preferably, the membrane layer has an S_{d} value of 0.008 m to 0.5 m, preferably from 0.009 m to 0.2 m, preferably from 0.01 m to 0.1 m.

The S_{d} value indicates the water vapor diffusion-equivalent air layer thickness and is a building physics measure for the water vapor diffusion resistance of a building component or a building component layer. The vapor permeability of a building material can be assessed using the S_{d} value. The water vapor diffusion resistance is clearly described by the thickness of an air layer that is necessary so that the same diffusion flow flows through the air layer in a stationary state under the same conditions as the building component under consideration. In particular, the flat sheet is designed to be open to diffusion, whereby the diffusion openness is characterized by an S_{d} value of less than or equal to 0.5 m.

The rainproofness and/or water vapor permeability of the composite film according to the invention can be ensured specifically by means of the diffusion-open and simultaneously waterproof design of the membrane layer. In this way, for example, moisture present in the building material or in a building structure can effectively diffuse outwards through the composite film according to the invention, while at the same time reliable protection of the building material or the structure against the penetration of liquid water is provided.

In addition, it has proved useful in the context of the present invention if the membrane layer is colorless, in particular translucent, preferably transparent.

As far as the layer comprising the nonwoven fabric of composite films according to the invention is concerned, it has proved useful if the composite film comprises one or more, in particular one or two, preferably one, layer comprising a nonwoven fabric. Preferably, it can also be provided that the layer comprising a nonwoven fabric consists of the nonwoven fabric. In this case, a layer consisting of a nonwoven fabric is to be assumed accordingly.

Furthermore, it has been found to be advantageous if the layer comprising a nonwoven fabric is designed as a reinforcing layer, in particular arranged on the inside of the composite film. According to the invention, it is therefore preferable if the layer comprising a nonwoven fabric is surrounded by further layers of the composite film, in particular, for example, by a nonwoven layer and/or membrane layer. Since the layer comprising a nonwoven fabric is preferably arranged on the inside and is designed as a reinforcing layer, the layer can ideally contribute to the stabilization and intrinsic rigidity of the composite film according to the invention. Due to the low stretchability of the nonwoven fabric, the composite film also has high dimensional stability. This additionally favors wrinkle-free installation. However, the layer comprising a nonwoven fabric is always designed in such a way that a sufficiently high degree of flexibility and mobility or pliability of the composite film is guaranteed

As far as the composition of the nonwoven fabric of the layer comprising a nonwoven fabric is concerned, the person skilled in the art can choose from a variety of possible materials. In the context of the present invention, it has proved useful if the nonwoven fabric comprises a polyolefin and/or a polyester, and in particular consists of a polyolefin and/or a polyester.

It has proven to be particularly advantageous if the polyolefin of the nonwoven fabric is selected from the group of polyolefin homopolymers, in particular polyethylene, polypropylene, polybutylene, preferably polyethylene, polypropylene, polyolefin copolymers, in particular ethylene copolymers, propylene copolymers, butylene copolymers, preferably ethylene copolymers, propylene copolymers, and mixtures thereof.

In a preferred embodiment of the composite film according to the invention, the polyolefin comprises or preferably consists of polyethylene.

Likewise, it has proved useful in the context of the present invention if the polyester is selected from the group of polyethylene terephthalate, polybutylene terephthalate, polytrimethylene terephthalate, polyethylene furanoate, their copolymers and their mixtures or blends, in particular polyethylene terephthalate, polybutylene terephthalate, polyethylene furanoate, their copolymers and their blends, in particular polyethylene terephthalate, polybutylene terephthalate, polyethylene furanoate, their copolymers and their mixtures or blends, preferably polyethylene terephthalate, polyethylene furanoate, their copolymers and their mixtures or blends.

According to a preferred embodiment of the composite film according to the invention, the polyester comprises or preferably consists of polyethylene terephthalate.

Furthermore, with regard to the nature of the nonwoven fabric, it has proven to be useful if the nonwoven fabric has a grammage in the range of 40 g/m² or less, in particular 35 g/m² or less, preferably 30 g/m² or less, preferably 27 g/m² or less. In the context of the present invention, therefore, a preferably thin or lightweight fabric is used. In this way, an ideal balance between reinforcement and stabilization of the film can be achieved while at the same time maintaining sufficient flexibility thereof.

According to the invention, it is envisaged that an open-mesh nonwoven fabric is used in the composite film. In this respect, it has also proved useful if the nonwoven fabric comprises cross-laminated nonwoven fabric strands, in particular consists of these.

Open mesh materials or fabrics are characterized by an open stitch pattern. Traditional knitted materials consist of intersecting threads or filaments that are woven or knitted together without the filaments being joined at their intersections. In contrast, open mesh nonwoven fabrics, such as those used in the present invention, comprise adjacent layers of slit and biaxially stretched webs which are joined together by thermal bonding or thermal fusing and not by weaving or knitting. In addition, cross-lamination is to be understood as a production method for nonwoven fabrics, among other things, in which a multi-layer, open-meshed fabric is produced by thermal bonding, whereby at least one of the several layers is arranged at right angles to the other layers with respect to the fiber direction or the direction of the strongest tension. In the context of the present invention, the nonwoven fabric preferably has two open-mesh layers which are cross-laminated.

Nonwoven fabrics produced or formed in this way are characterized by high dimensional stability and have high tensile and tear strengths in the longitudinal and transverse directions. These properties contribute to the stabilizing and strengthening effect of the nonwoven fabric and are advantageously fully reflected in the composite film according to the invention, so that it has a high inherent and dimensional stability and intrinsic strength while at the same time optimizing its weight. These advantageous properties facilitate in particular the laying of the composite film according to the invention or the application thereof to building materials or structures to be protected, whereby in particular, for example, wrinkling during laying due to insufficient stability of the film can be reliably avoided and thus the comfort for the user can be significantly increased.

According to the invention, it is preferably provided that the specific tensile strength of the nonwoven fabric is at least 90 N/5 cm in the machine direction and/or at least 120 N/5 cm in the transverse direction, preferably 110 N/5 cm in the machine direction and/or at least 140 N/5 cm in the transverse direction, preferably at least 140 N/5 cm in the machine direction and/or at least 150 N/5 cm in the transverse direction, particularly preferably at least 200 N/5 cm in the machine direction and/or at least 170 N/5 cm in the transverse direction. The specific tensile strength is measured according to EN 12311-1.

The machine direction refers to the direction in which the fabric was transported in or through the machine during production, i.e. regularly the lengthwise direction of a fabric web. The transverse direction, in which the fabric expands over its surface, refers to the direction at right angles to the machine direction, i.e. regularly the direction within the width of a fabric web.

By choosing nonwoven fabrics with cross-laminated nonwoven strands in particular, a flat, open-meshed fabric can also be obtained so that, for example, a build-up of material at knots or cross points can be prevented. This has the advantage that the formation of pressure points due to unevenness in the film material is avoided. In this aspect, the open-meshed nonwoven fabric used according to the invention, in particular comprising cross-laminated nonwoven fabric strands, differs significantly from conventional mesh fabrics used for reinforcement. Mesh fabrics tend to build up material at the junctions, resulting in elevations which can cause the formation of pressure points or increased mechanical abrasion in the material covered with a corresponding film, particularly in the case of wood materials. In the context of the present invention, this is specifically avoided, which is particularly advantageous for the use of composite films according to the invention for the protection of walkable surfaces.

It may also be provided that the layer comprising a nonwoven fabric is formed as a single or multiple layer, preferably as a single layer with respect to the nonwoven fabric as a whole. If the layer comprising a nonwoven fabric has several, i.e. at least two, layers of nonwoven fabric, it may be provided that the nonwoven fabric layers are formed differently or are formed at least substantially identically. Differently formed layers can result, for example, with regard to the selection of the nonwoven fabric or also the grammage.

Furthermore, it has proved useful in the context of the present invention if the nonwoven fabric is colorless, in particular translucent, preferably transparent. In this way, it can be advantageously achieved that the nonwoven fabric in the composite film according to the invention is not ultimately recognizable, so that a component covered with the composite film or a building structure provided with the composite film can be inspected without restriction and without distortion. In this way, the occurrence of defects can be detected at an early stage and the visual integrity of the building materials can be easily checked and determined.

For particularly breathable or diffusion-open and yet stable composite films, it may also be advisable to open-meshed nonwoven fabrics that have a proportion of open areas in the nonwoven fabric of up to 60%, in particular up to 65%, preferably up to 70%.

The open-mesh cross-laminated nonwoven fabric CLAF® from ANCI Inc. has proven to be particularly suitable in the context of the present invention.

The described properties of the aforementioned layers, i.e. the nonwoven layer, membrane layer and/or the layer comprising a nonwoven fabric, can be further optimized for the intended application and functionality of the composite film according to the invention by adding additives.

The addition of additives advantageously allows the material properties of the fibers or components used in the aforementioned layers within the scope of the present invention to be influenced or, in particular, optimized. In this sense, the targeted and directed use of additives makes it possible to positively influence composite films according to the invention.

Suitable additives can be selected from a wide variety of substances and can be used, for example, for coloring, thermostabilization, flame retardancy, hydrophilization or hydrophobization or for UV stabilization of the thermoplastic or the fiber as a whole. It is generally intended that the additives are distributed regularly or evenly in the respective layer. Particularly good results are obtained in the context of the present invention if the additive is a primary or secondary antioxidant, a UV absorber, a UV stabilizer, a flame retardant, an antistatic agent, a lubricant, a metal deactivator, a hydrophilizing agent, a hydrophobizing agent, an antifogging additive and/or a biocide. The following substance classes and mixtures thereof are particularly preferred:
a. Sterically hindered phenols, aromatic secondary or tertiary amines, aminophenols, aromatic nitro or nitroso compounds as primary antioxidants.
b. Organic phosphites or phosphonates, thioethers, thioalcohols, thioesters, sulphides and sulphur-containing organic acids, dithiocarbamates, thiodipropionates, aminopyrazoles, metal-containing mercaptobenzimidazoles as secondary antioxidants.
c. Hydroxybenzophenones, cinnamates, oxalanilides, salicylates, 1.3 benzenediol monobenzoates, benzotriazoles, triazines, benzophenones and UV-absorbing pigments such as titanium dioxide or carbon black as UV absorbers.
d. Metal-containing complexes of organic sulphur or phosphorus compounds, sterically hindered amines (HALS) as UV stabilizers.
e. Metal hydroxides, borates, organic compounds containing bromine or chlorine, organic phosphorus compounds, antimony matrix oxide, melamine, melamine cyanurate, expandable graphite or other intumescent systems as flame retardants.
f. Quaternary ammonium salts, alkyl sulphonates, alkyl sulphates, alkyl phosphates, dithiocarbamates, (earth) alkali metal carboxylates, polyethylene glycols and their esters and ethers, fatty acid esters, ethoxylates, mono- and diglycerides, ethanolamines as antistatic agents.
g. Fatty alcohols, esters of fatty alcohols, fatty acids, fatty acid esters, dicarboxylic acid esters, fatty acid amides, metal salts of fatty acids, polyolefin waxes, natural or artificial kerosenes and their derivatives, fluoropolymers and fluoroligomers, antiblocking agents such as silicas, silicones, silicates, calcium carbonate etc. as lubricants.
h. Amides of mono- and dicarboxylic acids and their derivatives, cyclic amides, hydrazones and bishydrazones, hydrazides, hydrazines, melamine and its derivatives, benzotriazoles, aminotriazoles, sterically hindered phenols in combination with complexing metal compounds, benzylphosphonates, pyridithiols, thiobisphenol esters as metal deactivators.
i. polyglycols, ethoxylates, fluoropolymers and fluoroligomers, montan waxes, in particular stearates, as hydrophilizing, hydrophobizing or anti-fogging agents.
j. 10,10′-oxybisphenoxarsine (OBPA), N-(trihalogen-methylthiol) phthalimide, tributyltin oxide, zinc dimethyldithiocarbamate, diphenylantimon-2-ethylhexanoate, copper-8-hydroxyquinoline, isothiazolones, silver and silver salts as biocides.

As far as the adhesive layer of composite films according to the invention is concerned, it has proved useful in the context of the present invention if the composite film has one or more, in particular one or two, preferably one, adhesive layers.

With regard to the arrangement of the adhesive layer, it is also preferably provided that the adhesive layer is arranged on the outside of the composite film. Preferably, in composite films according to the invention, one or more nonwoven layers are formed as a top layer or nonwoven top layer and/or a base layer or nonwoven bottom layer. According to the invention, it has proven to be useful if the adhesive layer is applied to at least one or more, in particular one, of these nonwoven layers, in particular to the nonwoven layer formed as a base layer or bottom nonwoven layer. In this respect, the nonwoven layer provided with an adhesive layer and formed as a base layer or sub-base layer can then also be understood as an inner or inner carrier or protective layer.

Similarly, according to the invention, it may preferably be provided that the adhesive layer is arranged on the side of the nonwoven layer facing away from the membrane layer and/or the layer comprising the nonwoven fabric, in particular on the nonwoven layer formed as a base layer or sub-base layer.

According to the invention, it is therefore preferably provided that the composite film is designed as a self-adhesive composite film. Preferably, the composite film is self-adhesive on one side, in particular with the adhesive surface being arranged on the underside, i.e. on the nonwoven layer formed as the base layer or lower nonwoven layer. The upper side of the composite film is therefore preferably formed by the nonwoven fabric designed as the top layer or upper nonwoven layer. Further preferably, the at least one membrane layer and the at least one layer comprising a nonwoven fabric are arranged between the nonwoven layers formed as the top layer or nonwoven top layer and/or the base layer or nonwoven bottom layer. Accordingly, the composite film according to the invention in the context of the preferred embodiment described comprises at least a five-layer structure.

With regard to the composition of the adhesive layer, the person skilled in the art can choose from a large number of possible adhesive materials. In the context of the present invention, it has proved useful if the adhesive layer comprises a, in particular a pressure-sensitive, contact adhesive, preferably consists thereof.

In this context, it is further preferred if the contact adhesive comprises an acrylate, in particular an acrylate contact adhesive, preferably a UV-curable acrylate contact adhesive.

In the context of the present invention, good adhesive properties are also achieved if the adhesive layer is comparatively thick or heavy. In particular, it has proven useful if the adhesive layer has a grammage in a range of 100 g/m² or less, in particular 90 g/m² or less, preferably 80 g/m² or less, preferably 75 g/m² or less.

It has also proven to be advantageous if the adhesive layer is formed over the entire surface or part of the surface, preferably over the entire surface. In this way, an efficient and durable bond of the composite film according to the invention with the substrate to be protected can be achieved, which is also well secured against slipping or unintentional at least partial detachment of the film.

Similarly, it may be provided in the context of the present invention that the adhesive layer is continuous or discontinuous, preferably discontinuous. According to the invention, a continuous adhesive layer means a continuous adhesive layer applied as a closed film. Accordingly, a discontinuous adhesive layer means an adhesive layer applied with interruptions or as a non-closed film.

In the preferred case that the adhesive layer is discontinuous, it has proven to be useful if the adhesive layer is designed as a grid, lattice, dot pattern, striped pattern or checkerboard pattern. However, other comparable patterns are also conceivable. In this way, a particularly efficient adhesive application can be achieved, while also effectively ensuring that a high adhesive performance of the composite film according to the invention is achieved.

According to the invention, it is preferred if the adhesive layer has a peel force in a range of 10 N or more, in particular 15 N or more, preferably 20 N or more, determined according to EN 4108-11. The peel force, also called adhesive force or peel adhesion, is the bonding force between the adhesive surface and the substrate and indicates how much force must be applied to detach the adhesive surface from the substrate. Peel forces in the aforementioned range advantageously ensure that premature detachment of composite films according to the invention is avoided and that the composite film according to the invention also remains firmly and securely positioned on the substrate to be protected, e.g. on structural components or a building structure, for the duration of its use.

In addition, it has proven useful in the context of the present invention if the adhesive layer is designed to be waterproof and open to diffusion. In this way, the adhesive layer supports the functioning of the composite film according to the invention, in particular the membrane layer, so that the diffusion of moisture, for example from wood construction materials, can take place unhindered through the composite film to the outside and at the same time the resistance of the composite film according to the invention to liquid water, for example from direct weathering, is ensured.

Advantageously, the adhesive layer can be covered with a liner (in particular a peel-off film). Once the liner has been removed, the composite construction film can be bonded.

As already explained, the various layers of composite films according to the invention are preferably colorless, in particular translucent, preferably transparent. In this sense, in the context of a preferred embodiment of the composite film according to the invention, it is envisaged that the composite construction film as a whole is colorless, in particular translucent, preferably transparent.

In a further preferred embodiment of the present invention, it may be provided that the nonwoven layer and/or the membrane layer and/or the further layer comprising an open-mesh nonwoven fabric are firmly bonded, in particular glued.

Consequently, an adhesive layer or bonding agent layer may be provided between the at least one membrane layer and the at least one nonwoven layer or between the at least one membrane layer and the at least one further layer comprising an open-mesh nonwoven fabric or between the at least one nonwoven layer and the at least one further layer comprising an open-mesh nonwoven fabric. The layers can be bonded during manufacture, in particular during the extrusion lamination process. Preferably, the bonding agent layer or the adhesive layer can be used to achieve a material bond between the layers to be joined together.

The adhesive or adhesion promoter layer can in particular be arranged on the outside of the nonwoven layer and/or the membrane layer and/or the further layer. Preferably, an adhesive layer or adhesion promoter layer is provided between the membrane layer and the nonwoven layer and/or the membrane layer and the further layer, in particular over the entire surface, preferably for a firm and materially bonded connection.

The adhesive or adhesion promoter layer may comprise a polymer, in particular an adhesion promoter polymer. The adhesion promoter polymer can preferably be a plastic and/or a synthetic resin, and preferably comprise a polyurethane. The adhesion promoter layer is preferably firmly bonded to the membrane layer, the nonwoven layer and/or the further layer

Particularly good results are achieved in this context if the adhesive or bonding agent layer is formed by a reactive PU hotmelt adhesive.

In the context of the present invention, it is usually provided that the adhesive or adhesion promoter layer is applied with a grammage of 2 to 20 g/m², in particular 4 to 15 g/m², preferably 5 to 10 g/m². The adhesive or bonding agent layer can be applied both to the membrane layer and to the nonwoven layer or the other layer.

Furthermore, the adhesive or adhesion promoter layer can also be integrated into the nonwoven layer and/or the membrane layer and/or the further layer—in such a way that the adhesion promoter polymer is enclosed and/or arranged in the surface area, in particular on the outside, of the aforementioned layers. Thus, the adhesion promoter layer can be formed as part or component of the membrane layer and/or the nonwoven layer and/or the further layer.

The bonding agent layer can be used to create a firm bond between the membrane layer and the nonwoven layer or the other layer. The adhesion promoter or the adhesion promoter polymer enables the fleece layer or the other layer to be permanently bonded to the membrane layer.

By incorporating functional materials, for example adhesion promoter polymers and/or flame retardants, it is also possible to achieve a cost-effective structure for the composite construction film according to the invention.

By using the adhesion promoter or the adhesion promoter polymer and/or the adhesion promoter layer in the outer layer of the nonwoven layer, the use of hotmelts can be dispensed with (hotmelt-free bonding). This means that the bonding agent and/or the adhesive can already ensure sufficient bonding or adhesion to the membrane layer.

However, it may also be advisable to use hot melts in the adhesive or bonding agent layer, with reactive hot melts being particularly preferred. The use of hot melts as adhesion promoters or adhesives can positively influence or further increase the ageing resistance as well as the cold and snow resistance of the composite construction film.

Preferably, the bonding agent or adhesive is also transparent or translucent.

In a preferred embodiment of the present invention, it may also be provided that the composite film is printed. The composite film can, for example, be printed with a grid, lattice, line pattern, dot pattern, measuring scales or the like. Preferably, the nonwoven layer of the laminated film, in particular in the form of a cover or nonwoven top layer, is printed.

Composite films according to the invention can be produced, for example, by means of extrusion lamination processes or by means of thermal lamination. In addition, the skilled person is also aware of other comparable processes which can be used to produce composite films according to the invention.

With regard to the further structure of the composite film, in addition to the already described preferred embodiments of the composite film and arrangements of the layers therein, it may be provided in a preferred embodiment of the present invention that the composite film comprises at least five layers, in particular two nonwoven layers, at least one membrane layer at least one layer comprising a nonwoven fabric and at least one adhesive layer, the layers being arranged in such a way that at least one layer comprising a nonwoven fabric followed by at least one membrane layer followed by the second nonwoven layer is arranged on one of the two nonwoven layers and the adhesive layer is arranged on the side of the nonwoven layer facing away from the membrane layer. It may further preferably be provided that the nonwoven layer and/or the membrane layer and/or the further layer comprising an open-mesh nonwoven fabric are firmly bonded, in particular glued.

Alternatively, it can also be provided that the layers are arranged in such a way that at least one membrane layer followed by at least one layer comprising a nonwoven fabric followed by the second nonwoven layer are arranged on one of the two nonwoven layers and the adhesive layer is arranged on the side of the nonwoven layer facing away from the layer comprising a nonwoven fabric.

In both cases of this preferred embodiment, the nonwoven layer on which the membrane layer or the layer comprising a nonwoven fabric and the adhesive layer are arranged is preferably designed as an inner carrier layer or in particular a protective layer. Accordingly, the nonwoven layer, on which only the layer comprising a nonwoven fabric or the membrane layer is arranged, is preferably designed as an outer carrier layer or, in particular, a protective layer. As an outer carrier layer or, in particular, protective layer, the nonwoven layer is preferably facing outwards in the application case, i.e. in the installed state, or represents the outside of the film, which is then exposed to the weather, for example. The composite film according to the invention is accordingly preferably connected to the building material to be protected or the building structure via the adhesive layer in the installed state, i.e. it forms the inward-facing side or also the inside of the film.

In a further preferred embodiment of the present invention, the composite film is a five-layer composite film comprising two nonwoven layers, in particular an outer or external nonwoven layer and an inner or internal nonwoven layer, a membrane layer, a layer comprising a nonwoven fabric and an adhesive layer.

Preferably, the membrane layer and the layer comprising a nonwoven fabric are arranged between the two nonwoven layers. Preferably, the layer comprising a nonwoven fabric is arranged on the outer nonwoven layer and the membrane layer is arranged between the layer comprising a nonwoven fabric and the inner nonwoven layer. The adhesive layer is preferably arranged on the side of the inner nonwoven layer facing away from the membrane layer.

A composite film with the advantageous configuration described above has an ideal property profile with regard to the intended use of the film, while at the same time having an optimized grammage and an efficiently coordinated number of layers.

A further object of the present invention—according to a second aspect of the present invention—is the use of a composite construction film according to the invention for the, in particular temporary, protection of building structures and/or structural components, in particular wooden structures and/or wooden structural components, from mechanical and/or weather-related damaging influences, in particular impact, shock, friction and/or scratching and/or driving rain, increased humidity, waterlogging.

For further details on this aspect of the invention, reference can be made to the above explanations on composite construction films according to the invention, which apply accordingly with regard to the use according to the invention.

The object of the present invention is further explained below by means of preferred embodiments by means of the figure illustration in a non-limiting manner.

FIG. 1 shows a multilayer composite construction film 5 according to the invention, in particular for the, preferably temporary, protection of building structures and/or structural components, preferably wooden structures and/or wooden structural components, from mechanical and/or weather-related damaging influences, for example during transportation, storage or assembly of the components or over the construction period of a building based on the building structure and/or the structural components, which comprises at least one nonwoven layer 1, wherein the nonwoven layer comprises a polyolefin, and at least one membrane layer 2, wherein the membrane layer comprises a polyurethane, at least one adhesive layer 4, wherein the adhesive layer comprises a contact adhesive, and at least one further layer 3, wherein the further layer 3 comprises an open-meshed nonwoven fabric.

As far as the nonwoven layer 1 is concerned, it has proven to be useful if the composite film 5 has one or more, in particular several, preferably two, nonwoven layers 1. The nonwoven layer 1 is preferably designed as a carrier layer, in particular as an outer carrier or protective layer 1a and/or inner carrier or protective layer 1b, preferably for the membrane layer 2 and/or the further layer 3 comprising a nonwoven fabric. Further advantageously, at least one of the several or, in particular, two nonwoven layers 1a or 1b is formed as a carrier layer and/or inner protective layer, i.e. as a base layer or also as a sub-base layer. Similarly, it is preferred if at least one of the several or, in particular, two nonwoven layers 1a or 1b is formed as a carrier layer and/or outer protective layer, i.e. as a top or nonwoven top layer.

According to the invention, the nonwoven layer 1 comprises a polyolefin and/or a polyester. It may preferably be provided that the nonwoven layer 1 consists of the polyolefin and/or polyester. It has proven to be advantageous if the polyolefin of the nonwoven layer 1 is selected from the group of polyolefin homopolymers, in particular polyethylene, polypropylene, polybutylene, preferably polyethylene, polypropylene, polyolefin copolymers, in particular ethylene copolymers, propylene copolymers, butylene copolymers, preferably ethylene copolymers, propylene copolymers, and mixtures thereof. Preferably, the nonwoven layer 1 has polypropylene or, in particular, consists of polypropylene. For the polyester, it is preferred if the polyester is selected from the group of polyethylene terephthalate, polybutylene terephthalate, polytrimethylene terephthalate, polyethylene furanoate, copolymers thereof and mixtures or blends thereof, in particular polyethylene terephthalate, polyethylene terephthalate, polyethylene furanoate, copolymers thereof and mixtures or blends thereof. blends, in particular polyethylene terephthalate, polybutylene terephthalate, polyethylene furanoate, their copolymers and their mixtures or blends, preferably polyethylene terephthalate, polyethylene furanoate, their copolymers and their mixtures or blends.

It has also proved useful if the nonwoven layer 1 has a grammage in the range of 70 g/m² or less, in particular 55 g/m² or less, preferably 50 g/m² or less, preferably 45 g/m² or less. Thus, according to the invention, comparatively thin or light nonwoven layers are preferred. Good results are also achieved in the context of the present invention if the nonwoven layer 1 has a layer thickness in the range from 0.01 mm to 2.5 cm, in particular 0.05 mm to 1.5 cm, preferably 0.1 mm to 1 cm.

According to the invention, it is also preferred if the nonwoven layer 1 is colorless, in particular translucent, preferably transparent.

It has also proved to be advantageous in the context of the present invention if the nonwoven layer 1 is formed as a spunbonded nonwoven and/or as a needlepunch nonwoven, and in particular is formed as a mechanically, chemically and/or thermally, preferably thermally, bonded nonwoven layer. Preferably, the nonwoven layer 1 is designed as a thermally bonded or needle-punched or wet-blast bonded nonwoven layer.

In addition, it is preferable for the nonwoven layer 1 to be slip-resistant.

With regard to the membrane layer 2, it has proved useful according to the invention if the composite film 5 has one or more, in particular one or more single-layer or multi-layer, preferably a single-layer, membrane layer 2.

If the membrane layer 2 has several, i.e. at least two, layers of membrane layers, as shown, for example, in FIG. 5, it may be provided that the membrane layer layers A and B are formed differently or are at least essentially identical. Differently formed layers A and B can result, for example, with regard to the selection of the polyurethane or copolyester elastomer or also the grammage.

With regard to the structure of the composite film 5 according to the invention, it has also proved to be advantageous in the context of the present invention if the membrane layer 2 is designed as a functional layer, in particular arranged on the inside of the composite film 5. An exemplary internal arrangement in the composite film 5 is shown in FIG. 1.

With regard to the material of the membrane layer 2, it is provided that the membrane layer comprises or consists of a polyurethane and/or thermoplastic copolyester elastomer. It is preferably provided that the polyurethane of the membrane layer 2 is a thermoplastic polyurethane (TPU) and/or a thermoplastic copolyester elastomer (TPC or TPEE), preferably a thermoplastic polyurethane (TPU). The thermoplastic polyurethane (TPU) is selected in particular from the group of aliphatic and aromatic polyurethanes of the ether type, the polyester type and the carbonate type, in particular from aromatic polyurethanes of the ether type, the polyester type and the carbonate type. In the context of a particularly preferred embodiment of the present invention, it may further be provided that the membrane layer 2 comprises the, in particular thermoplastic, polyurethane. With regard to the thermoplastic copolyester elastomer, this preferably comprises block copolymers, in particular with blocks of polyesters and polyethers.

Furthermore, it has proved useful if the membrane layer 2 has a grammage in a range of 40 g/m² or less, in particular 35 g/m² or less, preferably 30 g/m² or less, preferably 28 g/m² or less. It is also advantageous if the membrane layer 2 has a layer thickness in the range from 0.01 mm to 2.5 cm, in particular 0.05 mm to 1.5 cm, preferably 0.1 mm to 1 cm.

Furthermore, it is preferable for the membrane layer 2 to be monolithic. As far as the water vapor permeability of the membrane layer 2 is concerned, it is advantageous if the membrane layer 2 has an S_{d} value according to DIN EN ISO 12572 of less than 0.75 m, in particular less than 0.5 m, preferably less than 0.3 m, preferably less than 0.2 m. Equally preferably, the membrane layer 2 has an S_{d} value of 0.008 m to 0.5 m, preferably from 0.009 m to 0.2 m, preferably from 0.01 m to 0.1 m.

Finally, it is preferred according to the invention if the membrane layer 2 is colorless, in particular translucent, preferably transparent.

As far as the layer 3 comprising the nonwoven fabric of composite films 5 according to the invention is concerned, it has proved useful if the composite film 5 comprises one or more, in particular one or two, preferably one, layer 3 comprising a nonwoven fabric. Preferably, it can also be provided that the layer 3 comprising a nonwoven fabric consists of the nonwoven fabric.

It may also be provided that the layer 3 comprising a nonwoven fabric is formed in one or more layers, preferably in a single layer with respect to the nonwoven fabric as a whole. If the layer 3 comprising a nonwoven fabric has several, i.e. at least two, layers of nonwoven fabric, as shown, for example, in FIG. 6, it may be provided that the nonwoven fabric layers C and D are formed differently or are formed at least substantially identically. Differently formed layers C and D can result, for example, with regard to the selection of the nonwoven fabric or also the grammage.

In accordance with the preferred embodiment of the composite film 5 according to the invention shown in FIG. 1, the layer 3 comprising a nonwoven fabric is designed as a reinforcing layer, in particular arranged on the inside of the composite film 5.

As far as the composition of the nonwoven fabric of the layer 3 comprising a nonwoven fabric is concerned, it has proved useful if the nonwoven fabric comprises a polyolefin and/or polyester, in particular consists of a polyolefin and/or polyester. It is preferred if the polyolefin of the nonwoven fabric is selected from the group of polyolefin homopolymers, in particular polyethylene, polypropylene, polybutylene, preferably polyethylene, polypropylene, polyolefin copolymers, in particular ethylene copolymers, propylene copolymers, butylene copolymers, preferably ethylene copolymers, propylene copolymers, and mixtures thereof. In a preferred embodiment of the composite film 5 according to the invention, the polyolefin comprises or preferably consists of polyethylene. With regard to the polyesters, this is preferably selected from the group of polyethylene terephthalate, polybutylene terephthalate, polytrimethylene terephthalate, polyethylene furanoate, their copolymers and their mixtures or blends, in particular polyethylene terephthalate, polyethylene terephthalate, polyethylene terephthalate, polyethylene furanoate, their copolymers and their mixtures or blends, in particular polyethylene terephthalate, polybutylene terephthalate, polyethylene furanoate, copolymers thereof and mixtures or blends thereof, preferably polyethylene terephthalate, polyethylene furanoate, copolymers thereof and mixtures or blends thereof.

Furthermore, with regard to the nature of the nonwoven fabric, it has proven to be useful if the nonwoven fabric has a grammage in the range of 40 g/m² or less, in particular 35 g/m² or less, preferably 30 g/m² or less, preferably 27 g/m² or less.

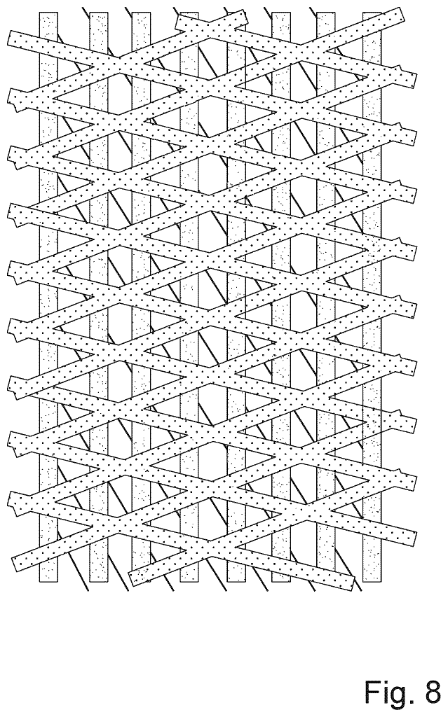

According to the invention, it is provided that an open-mesh nonwoven fabric is used in the composite film, as also shown in FIG. 8. Further preferably, the nonwoven fabric comprises cross-laminated nonwoven fabric strands, in particular consists of these. The nonwoven fabric shown in FIG. 8, which is preferably used according to the invention, is characterized by an open mesh pattern, which is obtained by joining adjacent layers of slit and biaxially stretched webs together by thermal bonding or thermal fusing. For cross-lamination, the layers are joined by thermal bonding in such a way that at least one of the several layers is arranged at right angles to the other layers in relation to the fiber direction or the direction of the strongest tension.

Preferred nonwoven fabrics have a specific tensile strength in the range of at least 90 N/5 cm in the machine direction and/or at least 120 N/5 cm in the transverse direction, preferably 110 N/5 cm in the machine direction and/or at least 140 N/5 cm in the transverse direction, preferably at least 140 N/5 cm in the machine direction and/or at least 150 N/5 cm in the transverse direction, particularly preferably at least 200 N/5 cm in the machine direction and/or at least 170 N/5 cm in the transverse direction. The specific tensile strength is measured according to EN 12311-1.

Furthermore, the nonwoven fabric is preferably colorless, in particular translucent, preferably transparent. For particularly breathable or diffusion-open and yet stable composite films, it may also be advisable to use open-meshed nonwoven fabrics that have a proportion of open areas in the nonwoven fabric of up to 60%, in particular up to 65%, preferably up to 70%.

With regard to the adhesive layer 4 of composite films 5 according to the invention, it has proved useful if the composite film 5 has one or more, in particular one or two, preferably one, adhesive layers 4.

With regard to the arrangement of the adhesive layer 4, this is preferably arranged on the outside of the composite film 5, in accordance with the preferred embodiment of a composite film 5 according to the invention as shown in FIG. 1. It has proved particularly useful if the adhesive layer 4 is applied to at least one or more, in particular one, nonwoven layer 1. In this respect, the nonwoven layer 1 provided with an adhesive layer 4 can then also be regarded as an internal or inner carrier or protective layer.

Preferably, the composite film 5 is designed as a self-adhesive composite film. Preferably, the composite film 5 is self-adhesive on one side, in particular with the adhesive surface 4 arranged on the underside. The upper side of the composite film is preferably formed by the nonwoven 1, which is designed as a cover or nonwoven top layer.

With regard to the composition of the adhesive layer 4, this preferably comprises a, in particular a pressure-sensitive, contact adhesive, preferably consists thereof. Here it is further preferred if the contact adhesive comprises an acrylate, in particular is an acrylate contact adhesive, preferably is a UV-curable acrylate contact adhesive.

In the context of the present invention, good adhesive properties are also achieved if the adhesive layer 4 is comparatively thick or heavy. In particular, it has proven useful if the adhesive layer 4 has a grammage in a range of 100 g/m² or less, in particular 90 g/m² or less, preferably 80 g/m² or less, preferably 75 g/m² or less.

Likewise, it has proven to be advantageous if the adhesive layer 4 is formed over the entire surface or over part of the surface, preferably over the entire surface. Similarly, it may be provided within the scope of the present invention that the adhesive layer is formed continuously or discontinuously, preferably discontinuously. In the preferred case that the adhesive layer 4 is formed discontinuously, it has proven useful if the adhesive layer 4 is formed as a grid, lattice, dot pattern, striped pattern or checkerboard pattern. However, other comparable patterns are also conceivable.

Advantageously, the adhesive layer 4 has a peel force in the range of 10 N or more, in particular 15 N or more, preferably 20 N or more, determined in accordance with EN 4108-11.

It has also proven to be a good idea if the adhesive layer 4 is waterproof and open to diffusion.

Advantageously, the adhesive layer 4 can also be covered with a liner (in particular a peel-off film). After removing the liner, the composite construction film 5 can then be bonded.

Preferably, the composite film 5 is also colorless, in particular translucent, preferably transparent. In the context of a preferred embodiment of the present invention, it may also be provided that the composite film 5 is printed, as shown in FIG. 10, for example. The composite film 5 can be printed with a grid, lattice, line pattern, dot pattern, measuring scales or the like. Preferably, the nonwoven layer 1 of the composite film 5 is printed.

In a preferred version of the composite film 5, it may be provided that the nonwoven layer 1 and/or the membrane layer 2 and/or the further layer 3 comprising an open-mesh nonwoven fabric are firmly bonded, in particular glued.

Consequently, an adhesive layer or adhesion promoter layer can be provided between the membrane layer 2 and the nonwoven layer 1 or between the membrane layer 2 and the further layer 3 or between the nonwoven layer 1 and the further layer 3. The layers can be bonded during manufacture, in particular during the extrusion lamination process. Preferably, the bonding agent layer or the adhesive layer can be used to achieve a material bond between the layers to be joined together.

The adhesive or adhesion promoter layer can in particular be arranged on the outside of the nonwoven layer 1 and/or the membrane layer 2 and/or the further layer 3. Preferably, an adhesive layer or adhesion promoter layer is provided between the membrane layer 2 and the nonwoven layer 1 and/or the membrane layer 2 and the further layer 3, in particular over the entire surface, preferably for a firm and materially bonded connection.

The adhesive or adhesion promoter layer may comprise a polymer, in particular an adhesion promoter polymer, which is preferably a plastic and/or a synthetic resin, and preferably comprises a polyurethane. The adhesion promoter layer is preferably firmly bonded to the membrane layer 2, the nonwoven layer 1 and/or the further layer 3. Particularly good results are achieved if the adhesive or bonding agent layer is formed by a reactive PU hot-melt adhesive.

It has also proved useful if the adhesive or bonding agent layer is applied with a grammage of 2 to 20 g/m², in particular 4 to 15 g/m², preferably 5 to 10 g/m². The adhesive or bonding agent layer can be applied both to the membrane layer 2 and to the nonwoven layer 1 or the other layer 3.

Preferably, the adhesive or bonding agent layer is transparent or translucent.

Furthermore, the adhesive or adhesion promoter layer can also be integrated into the nonwoven layer 1 and/or the membrane layer 2 and/or the further layer 3—in such a way that the adhesion promoter polymer is enclosed and/or arranged in the surface area of the aforementioned layers, in particular on the outside. The adhesion promoter layer can thus be formed as a part or component of the membrane layer 2 and/or the nonwoven layer 1 and/or the further layer 3.

As far as the structure of the composite film 5 is concerned, it can be made up of four layers, as shown in FIG. 1, whereby the composite film 5 comprises a nonwoven layer 1, a membrane layer 2, a layer 3 comprising a nonwoven fabric and an adhesive layer 4. The nonwoven layer 1 is advantageously configured as an outer or outer carrier layer, while the adhesive layer 4 forms the inside of the composite film 5. The membrane layer 2 and the layer 3 comprising a nonwoven fabric are arranged on the inside of the composite film 5, with the membrane layer 2 adjoining the nonwoven layer 1. The nonwoven layer 1 and/or the membrane layer 2 and/or the further layer 3 comprising an open-mesh nonwoven fabric are preferably firmly bonded, in particular glued.

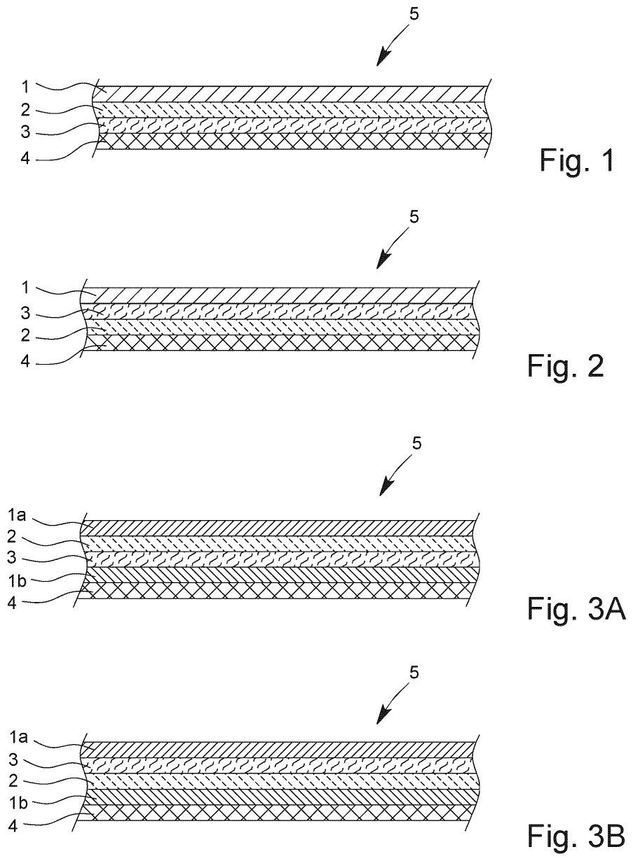

According to the alternative embodiment of the composite film according to the invention shown in FIG. 2, the layer 3 comprising a nonwoven fabric can also preferably be adjacent to the nonwoven layer 1.

FIG. 3A also shows a further, particularly preferred embodiment of the composite film 5 according to the invention. The composite film 5 is designed with five layers and comprises two nonwoven layers 1a and 1b, a membrane layer 2, a layer 3 comprising a nonwoven fabric and an adhesive layer 4. The layers are arranged in such a way that the membrane layer 2 is adjacent to the nonwoven layer 1a, which is advantageously designed as an outer carrier or protective layer. Membrane layer 2 is followed by layer 3, which has a nonwoven fabric and is in turn adjacent to nonwoven layer 1b, which is designed in particular as an inner carrier or protective layer. Finally, the adhesive layer 4 is arranged on the side of the nonwoven layer 1b facing away from the layer 3 comprising a nonwoven fabric, by means of which the composite film 5 can be bonded to the building material or structure to be protected. The nonwoven layer 1 and/or the membrane layer 2 and/or the further layer 3 comprising an open-mesh nonwoven fabric are preferably firmly bonded, in particular glued, to one another.

Alternatively, as shown in FIG. 3B, it can also be provided that the membrane layer 2 and the layer 3 comprising a nonwoven fabric are arranged inverted, i.e. the layer 3 comprising a nonwoven fabric is arranged adjacent to the nonwoven layer 1a, which is advantageously designed as an outer carrier or protective layer, followed by the membrane layer 2, which in turn is adjacent to the nonwoven layer 1b, which is designed in particular as an inner carrier or protective layer.

In both cases of this preferred embodiment, a robust and resistant composite film 5 is obtained, which is ideally suited for use as a protective film, in particular for the protection of building materials or structures during construction. The composite film 5 has a high inherent stability and resistance to mechanical stress compared to known protective films. The composite film 5 is also advantageously resistant to driving rain and water and is also open to diffusion for water vapor. In addition, it has good flatness combined with sufficient flexibility and pliability, so that the composite film 5 is ideally suited for covering both walkable surfaces and geometrically more complex components. The composite film 5 is easy to handle due to its intrinsic stability, which is provided in particular by the layer 3 comprising a nonwoven fabric, and can therefore be laid or applied to a building material or construction in an efficient and time-saving manner.

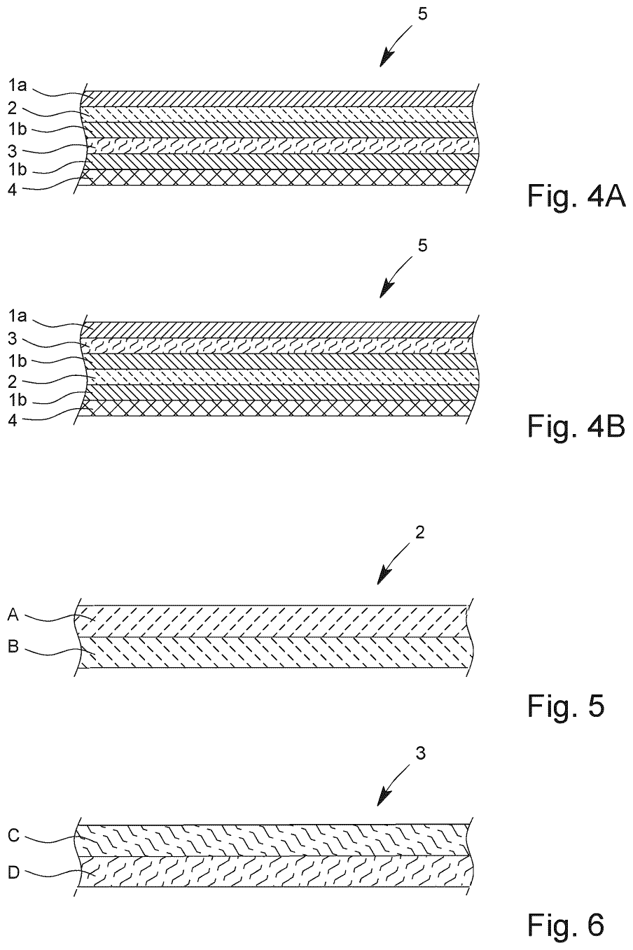

FIGS. 4A and 4B show two further preferred embodiments of the composite film 5 according to the invention. The composite film 5 has a six-layer structure in each case. In contrast to the design of the film according to FIGS. 3A and 3B, the composite film 5 according to FIGS. 4A and 4B has an additional nonwoven layer 1b, which is designed in particular as an additional inner or internal carrier or protective layer. The additional nonwoven layer 1b contributes to increasing the stability and robustness or resistance of the composite film 5. Accordingly, composite films 5, as shown in FIGS. 4A and 4B, are suitable for applications in which a high mechanical load-bearing capacity of the composite film is required in particular.

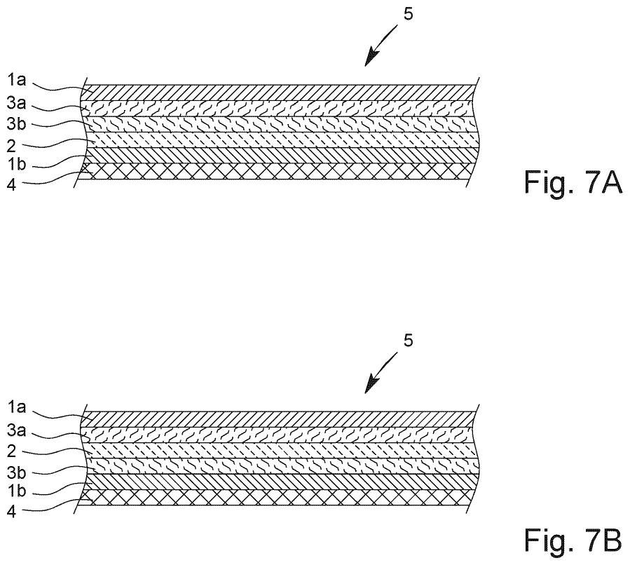

In addition, two further preferred embodiments of the composite film 5 according to the invention are shown in FIGS. 7A and 7B. In contrast to the embodiment of the composite film 5 according to FIGS. 3A and 3B, the composite films comprise a six-layer structure, wherein a further layer 3 comprising a nonwoven fabric is provided. The composite films according to FIGS. 7A and 7B thus have a layer 3a comprising a nonwoven fabric and a layer 3b comprising a nonwoven fabric. In this way, the intrinsic stability of the composite film 5 can be increased and a composite film with a high intrinsic stability and dimensional stability can be obtained. The layers 3a and 3b comprising a nonwoven fabric can be arranged directly on top of each other, as in FIG. 7A. Alternatively, the layers 3a and 3b comprising a nonwoven fabric can also each be arranged on one side of the membrane layer 2 or each on the nonwoven layers 1a and/or 1b, as shown in FIG. 7B. In this way, the membrane layer is additionally protected and supported and a composite film 5 can be obtained that is balanced in terms of stability and functionality and is particularly resilient and durable.

In addition to the above-mentioned preferred embodiments of the composite film 5 according to the invention, further embodiments of the composite film 5 are also conceivable, in particular those with seven layers or more, which can then correspondingly comprise further nonwoven layers 1, membrane layers 2, layers 3 comprising a nonwoven fabric or also adhesive layers 4 and are in this respect also covered by the present invention.

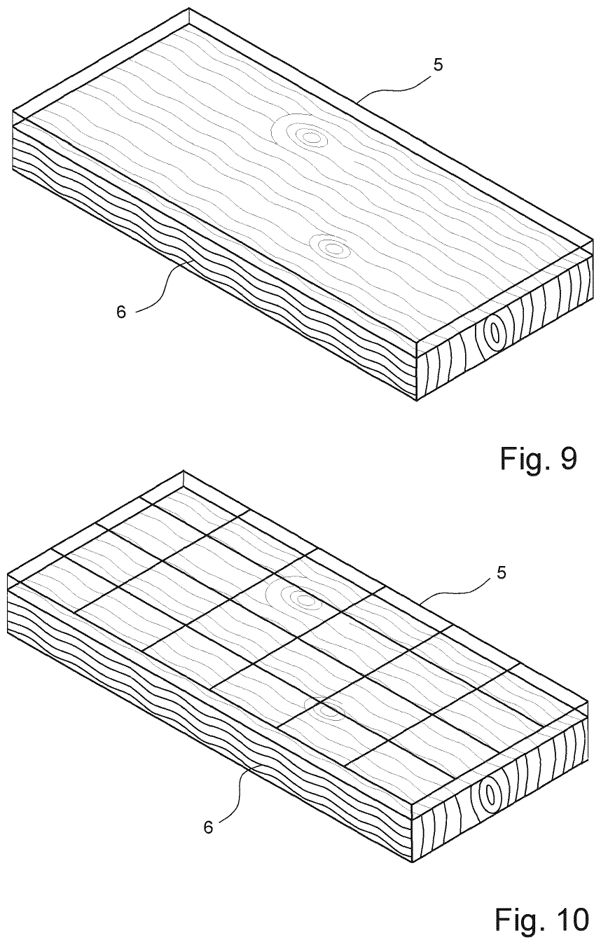

As already explained, the various layers 1 to 4 of composite films 5 according to the invention are preferably colorless, in particular translucent, preferably transparent. In this sense, it is correspondingly preferred for the composite film according to the invention, as shown in FIG. 9, if the composite construction film 5 as a whole is colorless, in particular translucent, preferably transparent. Thus, for example in the case shown in FIG. 9, in which the composite film 5 is applied to a wood construction material 6, the surface properties of the wood construction material 6 can still be recognized and, in particular, it can be visually verified whether or that the wood construction component based on the applied composite film 5 remains intact and undamaged, in particular during transport, storage and assembly of the construction component and over the duration of the construction period until completion of the structure in which the construction component 6 is used.

As shown in FIG. 10, it may also preferably be provided that the composite film 5 is printed. The composite film 5 can, for example, be printed with a grid, lattice, line pattern, dot pattern, measuring scales or the like. Preferably, the nonwoven layer 1 of the composite film 5 is printed. In this way, processing, e.g. cutting to size, of a component 6 covered with the composite film can be facilitated at, while at the same time ensuring that the surface of the component is protected throughout.

List of reference symbols:

i. Nonwoven layer
ii. Membrane layer
iii. Nonwoven fabric layer
iv. Adhesive layer
v. Composite film
vi. Wood building material

1. A multilayer composite construction film for protecting building structures and/or structural components, the composite construction film comprising:
a nonwoven layer comprising a polyolefin and/or a polyester;
a membrane layer comprising a polyurethane and/or a thermoplastic copolyester elastomer;
an adhesive layer comprising a contact adhesive; and
an open-meshed nonwoven fabric.

2. The composite construction film according to claim 1, wherein the nonwoven layer comprises at least two, nonwoven layers.

3. The composite construction film according to claim 1, wherein the polyolefin of the nonwoven layer comprises polyethylene, polypropylene, polybutylene, polyolefin copolymers, ethylene copolymers, propylene copolymers, butylene copolymers, propylene copolymers, and mixtures thereof.

4. The composite construction film according to claim 1, wherein the polyester comprises polyethylene terephthalate, polybutylene terephthalate, polytrimethylene terephthalate, polyethylene furanoate, their copolymers and their mixtures and/or blends thereof.

5. The composite construction film according to claim 1, wherein the nonwoven layer has a grammage in a range of 70 g/m2 or less.

6. The Composite construction film according to claim 1, wherein the membrane layer comprises only a single layer.

7. The composite construction film according to claim 1, wherein the membrane layer comprises a thermoplastic polyurethane (TPU) and/or a thermoplastic copolyester elastomer (TPC).

8. The composite construction film according to claim 7, wherein the thermoplastic polyurethane (TPU) is selected from the group of aliphatic and/or aromatic polyurethanes of the ether type, the polyester type and/or the carbonate type.

9. The composite construction film according to claim 1, wherein the membrane layer has a grammage in a range of 40 g/m2 or less.

10. The composite construction film according claim 1, wherein the composite film has at least one layer comprising a nonwoven fabric.

11. The composite construction film according to claim 10, wherein the at least one layer comprising the nonwoven fabric is designed as a reinforcing layer.

12. A composite construction film according to claim 1, wherein the nonwoven fabric comprises a polyolefin and/or a polyester.

13. The composite construction film according to claim 1, wherein the nonwoven fabric has a grammage in the range of 40 g/m2 or less.

14. The composite construction film according to claim 1, wherein the nonwoven fabric comprises cross-laminated nonwoven fabric strands.

15. The composite construction film according to claim 1, wherein the adhesive layer comprises two or more adhesive layers.

16. The composite construction film according to claim 1, wherein the adhesive layer is arranged on an outside of the composite film.

17. The composite construction film according to claim 1, wherein the contact adhesive comprises a pressure-sensitive contact adhesive.

18. Use of the construction composite film according to claim 1 to provide temporary, protection of building structures and/or structural components against mechanical and/or weather-related damaging influences.

19. The composite construction film according to claim 11, wherein the reinforcing layer is arranged on an inside of the composite construction film.

20. The composite construction film according to claim 16, wherein the outside of the composite construction film is on a side of the nonwoven layer facing away from the membrane layer and/or a layer comprising the nonwoven fabric
